(19) United States
(12) Patent Application Publication
(10) Pub. No.: US 2024/0342983 A1
(43) Pub. Date: Oct. 17, 2024

(54) SYSTEMS AND METHODS FOR THREE-DIMENSIONAL PRINTING

(71) Applicant: The Regents of the University of Colorado, a Body Corporatate, Boulder, CO (US)

(72) Inventor: Charles Rackson, Boulder, CO (US)

(73) Assignee: The Regents of the University of Colorado, a Body Corporatate, Boulder, CO (US)

(21) Appl. No.: 18/682,743

(22) PCT Filed: Aug. 10, 2022
(86) PCT No.: PCT/US2022/039897

§ 371 Date: Feb. 9, 2024

Related U.S. Application Data
(60) Provisional application No. 63/231,395, filed on Aug. 10, 2021.

(51) Int. Cl. B29C 64/124; B29C 64/268; B29C 64/291; B29K 105/00; B33Y 10/00; B33Y 30/00

(52) U.S. Cl. CPC B29C 64/124; B29C 64/268; B29C 64/291; B33Y 10/00; B33Y 30/00; B29K 2105/0088

(57) ABSTRACT

The disclosure provides systems and methods of 3D manufacturing of striation-free objects using volumetric additive manufacturing (VAM) techniques. The systems and methods include irradiation of a photocurable resin for a pre-gelation duration and subsequent energy delivery with a diffuse curing system to produce a 3D printed object without striations.

### CROSS-REFERENCE TO RELATED APPLICATION

This application claims priority under 35 U.S.C. § 119 (e) to U.S. Provisional Patent Application Ser. No. 63/231,395, filed Aug. 10, 2021, the disclosure of which is incorporated herein by reference in its entirety.

### STATEMENT REGARDING FEDERALLY SPONSORED RESEARCH

This invention was made with government support under 07NA27344 and JRNL-828179 awarded by the U.S. Department of Energy. The government has certain rights in the invention.

### BACKGROUND

Three-dimensional printing (“3D printing”) and multi-step additive manufacturing (AM) are being pursued for many diverse applications like, rapid prototyping, orthodontics, automotive parts, regenerative medicine, printing optics, microfluidics, composites with overprinting, etc. However, inherent to multi-step AM are layering effects which limit the performance and applications of printed parts via mechanical inhomogeneity and anisotropy, non-uniform refractive index of printed optics, and cosmetic imperfection. In certain applications (e.g. printing optics, or uniform-in-modulus parts), inhomogeneities in material properties (e.g. refractive index, modulus, chemical functionality, and so forth) may limit the application of 3D printing generally. The relatively new field of Volumetric Additive Manufacturing (VAM) performs printing directly into a 3D resin volume, avoiding the sequential processing steps currently in use. In VAM, a series of 2D optical patterns are projected into a rotating volume of photosensitive liquid resin. Over a short period of time (e.g., tens of seconds to a few minutes), the accumulated optical dose distribution polymerizes the material, resulting in an arbitrary 3D structure, and the printed part is removed from the remaining liquid resin. The typical goal of 3D polymeric printing generally, and VAM specifically, is to fabricate a 3D part in which voxels receive local optical dose to be either above or below the gelation threshold of the resin (e.g., known as Binary VAM printing). The simplest VAM printing geometry, in which images are projected orthogonally to the resin's axis of rotation, can be considered as a collection of independent 2D reconstruction problems. For each horizontal 2D slice-region in the resin, the computational problem is to choose the set of 1D projected images that integrate together to exceed a dose-to-gelation threshold for in-part voxels, while remaining below this threshold for out-of-part voxels, thus printing a desired geometry.

VAM is free of many of the constraints of multi-step AM. Notably, layering effects are effectively eliminated, non-contiguous parts become possible, and the lack of material-movement mid-print enables high-viscosity resins, without penalty to print-time, opening the doors to a host of new material properties. However, there remain challenges to solve in the field of VAM. For example, VAM suffers from striations in the final print. Striations can be in the form of surface ridges, and non-uniformities in conversion and density. This limits the applications of VAM printed parts (e.g., due to material property non-uniformity including mechanical modulus and refractive index; due to geometric non-uniformity, etc.). Thus, it would be desirable to provide a method or system to reduce or eliminate striations during a VAM or related 3D printing applications. The present disclosure solves this unmet need.

### SUMMARY

Systems and methods for three-dimensional (3D) printing are described herein. In some aspects of the present disclosure, a method of three-dimensional printing includes the steps of: i) irradiating a volume of at least one photocurable resin with at least one directional light source for at least a portion of a pre-gelation duration to form a latent image; and ii) flood irradiating the volume of the at least one photocurable resin with at least one diffuse curing system to cure the latent image and form a cured image, the diffuse curing system including at least one of an angularly diffuse light source, a spatially diffuse light source, a chemical curing system, and a thermal curing system, wherein the cured image has reduced striations.

In other aspects of the present disclosure, a system for three-dimensional printing is provided. The system includes at least one directional light source. The system also includes at least one diffuse curing system. The diffuse curing system may include at least one of an angularly diffuse light source, a spatially diffuse light source, a chemical curing system, and a thermal curing system. The system also includes a control subsystem in electronic communication with the at least one directional light source and the at least one diffuse curing system. The control subsystem is configured and adapted to: irradiate a volume of photocurable resin with the at least one directional light source for a pre-gelation duration; and flood irradiate the volume of photocurable resin with at least one diffuse curing system

### BRIEF DESCRIPTION OF THE DRAWINGS

For a fuller understanding of the nature and desired objects of the present disclosure, reference is made to the following detailed description taken in conjunction with the accompanying drawing figures wherein like reference characters denote corresponding parts throughout the several views.

FIG. 1 depicts a conventional VAM print process (marked steps “A” and “B”) and a resultant dental aligner print (marked “C”) exhibiting typical striations. Initial local gelation causes focusing, leading to a self-written-waveguide (SWW) effect, manifesting as striations (scale bar: 3 mm).

FIG. 2 depicts a latent-image process of the present disclosure. At marked step “D”, patterning is stopped just before gelation occurs, leaving a 3D latent image of polymer conversion that is higher in the desired print region than in the surrounding resin. At marked step “E”, the latent image is developed across the gelation threshold via a diffuse curing system (e.g., diffuse, uniform LED illumination), driving only the desired region to gelation. The resultant print (marked “F”) exhibits dramatically reduced striations, with a smooth surface and improved refractive index homogeneity.

FIG. 3 depicts scanning electron microscopy (SEM) scans of typical striations in conventional VAM prints. Specifically, a printed cone is illustrated with the axis of rotation aligned with the central axis of the cone. A roughly 60 μm striation pitch was measured both near the tip of cone, where the focused beam size was measured to be 11 μm, and near the base of the cone, where the beam size was 23 μm. A single projector pixel was measured to have a focused size of 6 and 18 μm at the center and at the edge of the print, respectively.

FIG. 4 depicts a slab print (the same geometry as in FIGS. 5B, and 6B) exhibiting irregular striations. The scale bar equates to 1 mm.

FIGS. 5A-5B depict shadowgrams of conventional VAM prints of a slab showing striations on the order of feature size upon completion. The scale bar equates to 1 mm. The shadowgrams were captured with the basic collimated LED shadowgraph setup.

FIGS. 6A-6B depict striation mitigation and improved shape fidelity (as compared to the striation of the print of FIGS. 5A-5B using the same programmed geometry) by the method of the present disclosure (e.g., latent cure method). Striations are largely eliminated, both in surface roughness, and in refractive index uniformity shown via shadowgrams of prints still immersed in resin. The scale bar equates to 1 mm. The shadowgrams were captured with the basic collimated LED shadowgraph setup.

FIG. 7 depicts a shadowgram of a conventional VAM print of a mesh showing striations on the order of feature size upon completion. The scale bar equates to 1 mm.

FIG. 8 depicts striation mitigation and improved shape fidelity (as compared to the striation of the print of FIG. 7 using the same programmed geometry) by the latent cure method of the present disclosure.

FIGS. 9A-9B depict shadowgrams of a conventional VAM print of a tilted mesh showing striations on the order of feature size upon completion. The scale bars of FIGS. 9A and 9B equate to 1 mm and 500 μm, respectively.

FIGS. 10A-10B depict striation mitigation and improved shape fidelity (as compared to the striation of the print of FIGS. 9A-9B using the same programmed geometry) by the latent cure method of the present disclosure.

FIG. 11 depicts a SEM scan of conventional VAM print of a mesh showing striations on the order of feature size upon completion. The scale bar equates to 1 mm.

FIG. 12 depicts striation mitigation and improved shape fidelity (as compared to the striation of the print of FIG. 11 using the same programmed geometry) by the latent cure method of the present disclosure

FIG. 13 depicts latent cure as a method of speeding the gelation period (GP) in a low power VAM print. In the sections marked “A”, “B”, “C”, and “D”, a conventional VAM process is illustrated, suffering from low print power and low viscosity resin. The partially-gelled regions sink before the part is complete. In the section marked “D”, a severely distorted final parT is illustrated. In the sections marked “E”, “F”, “G”, and “H”, a VAM print with latent cure used to quickly develop the entire print through its GP before significant sinking occurs is illustrated. Even though the patterning process and viscosity were unchanged from A-D, the rapid gelation via latent cure results in a significantly improved print (see section marked “H”). The GP could be easily further shortened by increasing the power of the latent exposure. In this case, a GP of only a few seconds was difficult to control, so the latent-cure power was reduced so that gelation could be easily observed, and the latent exposure stopped before unwanted gelation. Prints for FIG. 13 were done on a 405 nm LED-based CAL printer (DLI 3DLP9000 UV retrofitted with a telecentric lens) with a peak print-plane intensity of 65 mW/cm². Low viscosity resin (<1 Pa·s, α=0.2852 cm⁻¹, E_{c}≈125 mJ/cm³) was prepared with a 1:1 molar ratio of tris [2-(acryloyloxy) ethyl] isocyanurate (TAE-ICN, Sigma) to poly (ethylene glycol) diacrylate (PEGDA, Mₙ=575, Sigma) and 40 mM of Irgacure 907 (Sigma) as photoinitiator. The mixture was stirred at 60° C. until all the TAE-ICN crystallites were dissolved. In conventional VAM printing of the hollow cube FIG. 13, the print was deemed completed after 330 s. In the latent VAM case, after 215 s of patterned irradiation a 12 s latent exposure is applied to complete the print. Latent curing was done with an OmniCure S2000 Spot UV Curing system with a 405 nm filter with a custom diffuser on the output resulting in an approximate latent curing intensity of 150 mW/cm².

FIG. 14 depicts an example VAM print exhibiting striations.

FIGS. 15A-15C depicts an example VAM print exhibiting striations. FIGS. 15B and 15C illustrate close up views of portions of FIG. 15A

FIG. 16A depicts an example VAM print exhibiting striations.

FIGS. 16B-16D depicts a SEM image of the print of FIG. 16A showing surface ripples. The pitch of the ripples varies (e.g., indication that striation is not driven by optical writing resolution limits).

FIGS. 17-18 illustrate that photo-curable resin forms self-written waveguides. As illustrated, when gelation starts, a seed-point of higher refractive index focuses subsequent writing beams, which then causes more gelation propogating beyond that point. This illustration shows that a beam of light coming from a particular direction causes a waveguide (e.g., a striation) as the material undergoes a phase change from liquid to solid

FIG. 19 depicts a printed part using conventional VAM techniques. Typical large striations resulting from VAM are illustrated. Surface shape-defects are illustrated. The illustrated striations likely form refractive index inhomogeneities due to the increase polymer conversion within each striation. Mechanical property homogeneity is likely impacted by the non-uniform polymer conversion. Shape defects, mechanical defects, and the cosmetic defect from inhomogeneous refractive index all negatively impact the application of this VAM print as a dental aligner.

FIG. 20 depicts a printed part using a latent image approach of the present disclosure. The effects of striations (if any) are no longer detected visually. The visual clarity of the part suggests a smooth surface, as well as improved refractive index homogeneity. This print suggests improved homogeneity of mechanical properties.

FIG. 21 depicts a SEM scan of the latent-image printed part of FIG. 20, illustrating a smooth surface free from surface ripples formed from regular VAM printing.

FIG. 22 depicts a printed part using a latent image approach of the present disclosure. The optical clarity is of the part is illustrated as the staple ridges from the background can be seen through the printed part.

FIG. 23 depicts rotation of a vial that holds a photosensitive material into which a VAM projection system prints. Also depicted is the rectangular refractive index matching bath that surrounds the vial. This allows for an optically flat surface into which the writing beams can enter without distortion. The bath may help to refract, reflect, and otherwise scatter the flood-exposure light.

FIG. 24 depicts an example of an LED with a diffuser that could be used as a latent-cure source. For latent prints in many examples of this disclosure, such an LED and diffuser was aimed up at the bottom corner of an index match bath to provide a diffuse flood cure.

FIG. 25 depicts an example of one slice-region of a simulated optical dose tomographic VAM reconstruction. The mesh in-part regions are higher in optical energy than the surrounding out-of-part regions. Thus, preferential gelation is possible, allowing the part to gel without the surrounding regions undergoing unwanted gelation.

FIG. 26 depicts a histogram showing counts of optical dose-value for all voxels in the reconstruction shown in FIG. 25. The right-most histogram peak depicts the dose of the in-part voxels. The left-most histogram peak depicts the dose distribution of the out-of-part voxels. The gap between the histograms means that preferential gelation is possible without error. Many embodiments of the present disclosure (e.g., latent method) patterns with such a distribution. Before any gelation occurs, the patterning light is stopped. Then, the flood cure pushing the right-most (in-part) histogram peak from being below a gelation threshold, to being above the gelation threshold. Since the flood exposure is applied to all voxels, the contrast of the applied dose is slightly reduced. Preferential gelation is preserved, and a print successfully forms.

FIG. 27 depicts in-part and out-of-part dose histograms, in normalized units, of VAM reconstructions. The top image shows a process window of 9.1%. Adding a latent flood exposure to the entire volume shrinks that to 8.2%, slightly reducing the error tolerance of the printing process (e.g. timing, illumination uniformity, etc.). When a VAM print is stopped just prior to the gelation of any voxels, the in-part histograms highest values are just under the gelation threshold. Thus, to push these in-part voxels to gelation, a dose equal to the width of the in-part histogram (the In Part Dose Range), must be added. Adding this value of dose to all voxels, both in and out of part, reduces the contrast of the reconstruction. However, as long as the histograms are separated by a positive value, the gelation threshold can be chosen to lie between them, thus gelling all in-part voxels without inadvertently gelling any out-of-part voxels.

FIG. 28 depicts a sketch of a resin response requiring a large process window to avoid gelation errors. Consider a resin that requires a degree of conversion beyond gelation in order to survive post processing. The additional dose required to attain this conversion requires a process window of at least that dose in order to avoid unwanted out-of-part gelation.

FIG. 29 depicts a shadowgram showing the development of the cone print from FIG. 3. The formation of striations is visible upon the initial gelation.

### DEFINITIONS

The instant disclosure is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

The term “unidirectional light source” as used herein is taken to mean a device or system which directs optical energy (e.g., light, a laser beam, a plurality of laser beams, etc.) to selectively affect a 3D printable material (e.g., a resin, a photosensitive resin, a polymer, etc.).

The term “diffuse curing system” as used herein is taken to mean a device or system which directs energy (e.g., optical energy, light, radiation, heat, chemical stimuli, etc.) in a diffuse manner (e.g., angularly diffuse, spatially diffuse, distributed, unfocused, non-directional, etc.).

The term “spatially diffuse light source” as used herein refers to a source of electromagnetic radiation, for example, and without limitation, visible, UV, or infrared light, that directs in a diffuse manner, for example not having a specific constant intensity in a particular direction.

The term “angularly diffuse light” as used herein refers to any sort of illumination where the light propagation direction is not orthogonal to the resin axis of rotation. In certain embodiments, the VAM project itself could be used as an angularly diffuse flood source if all its pixels were turned on and the axis of rotation was first tilted by at least a few degrees with respect to the illumination direction (e.g., where further increasing tilt may further reduce striation effects). Angularly diffuse light can come from a large collection of angles, both in azimuthal and polar directions (e.g., which can increase the quality of striation suppression). In certain exemplary embodiments, a latent source can deliver angularly diffuse light from all hemispherical angles and positions (e.g., using an integrating sphere to deliver a latent cure dose).

### DETAILED DESCRIPTION

A method of three-dimensional (3D) printing is provided. The method includes the steps of irradiating a volume of at least one photocurable resin with at least one directional light source for at least a portion of a pre-gelation duration to form a latent image; and flood irradiating the volume of the at least one photocurable resin with at least one diffuse curing system to cure the latent image and form a cured image, the diffuse curing system including at least one of an angularly diffuse light source, a spatially diffuse light source, a chemical curing system, or a thermal curing system, wherein the cured image has reduced striations. The pre-gelation duration is a shorter period than would be used to fully cure a photocurable resin with a directional light source. In various embodiments, the pre-gelation duration is about 80-95% of the period necessary to fully cure a particular photocurable resin. In various embodiments, the pre-gelation duration is about 80, 81, 82, 83, 84, 85, 86, 87, 88, 89, 90, 91, 92, 93, 94, or about 95% of the period necessary to fully cure a particular photocurable resin. In various other embodiments, the pre-gelation duration is about 30-50% of the period necessary to fully cure a particular photocurable resin. In various other embodiments, the pre-gelation duration is about 30, 31, 32, 33, 34, 35, 36, 37, 38, 39, 40, 41, 42, 43, 44, 45, 46, 47, 48, 49, or about 50% of the period necessary to fully cure a particular photocurable resin. In various other embodiments, the pre-gelation duration is about 5-30% of the period necessary to fully cure a particular photocurable resin, or about 5, 10, 15, 20, 25, or about 30% of the period necessary to fully cure a particular photocurable resin. In many applications and in certain embodiments of the present disclosure, the photocurable resin can be a photocurable liquid resin. However, suitable resins in the present disclosure are not so limited. Suitable resins (e.g., photocurable resins) include, but are not limited to, acrylate-based resins and thiol-ene-based resins. Suitable resins (e.g., photocurable resins) can be liquid, non-liquid, partially liquid, and partially non-liquid resins. Suitable resins include (partially or entirely) urethane, methacrylate, epoxy, silicone resins, and the like. Certain suitable resins can include a plurality of resins. Certain suitable resins can be cured (at least partially) by different forms of energy (e.g., heat, chemicals, vibration, ultrasound, high-power optical energy, low power optical energy, visible light, non-visible light, radiative energy, etc.).

In various embodiments, the at least one directional light projector is a LED source or a laser radiation source. The wavelength of light used to cure the photocurable resin can include both single wavelengths in the case of lasers, or a distribution of wavelengths in the case of LEDs. In some embodiments, the directional light source has a wavelength of about 350 to about 650 nm, or about 250, 360, 370, 380, 390, 400, 410, 420, 430, 440, 450, 460, 470, 480, 490, 500, 510, 520, 530, 540, 550, 560, 570, 580, 590, 600, 610, 620, 630, 640, or about 650 nm.

In various embodiments, the at least one directional light projector includes a photocuring 3D printer. Suitable photocuring 3D printers include stercolithography (SLA) printers, Anycubic Photon Mono X, certain Formlab printers, certain Carbon3D printers, and the like.

In various embodiments, the pre-gelation duration is a period sufficient to at least partially cure the photocurable resin with the directional light projector before gelation occurs.

In various embodiments, a plurality of angularly diffuse light sources are used.

In various embodiments, striations in the cured image are absent (or reduced).

In various embodiments, the diffuse curing system includes at least one light diffuser (e.g., transmissive or reflective light diffuser). The light diffuser can be used with directional light projector as a filter to cause directional light to become more diffuse. In various embodiments, the diffuse curing system includes at least one of a LED source or a non-LED source. Non-LED sources include, for example, thermal, ultrasound or chemical curing sources. Thermal curing sources include, for example, heat lamps, ovens, and the like. Such thermal sources can be paired with a thermal radical initiator in the resin (e.g., a photo-initiator used to make the material sensitive to photons, additionally mixed-in thermal initiator to make the material sensitive to heat, etc.).

Thermal initiators (such as photoinitiators) create radicals upon their stimulation to initiate conversion (e.g. crosslinking). Ultrasound (or ultrasonic) curing sources can be used to apply energy (e.g., to increase heat). Chemical curing sources include, for example, a combination of a chemical catalyst and heat; polyamines (such as those used to cure epoxies); acetic acid (e.g., used to vulcanize silicones); acrylates; additives such as thiols, nucleophiles, or a base; ring-opening polymerization systems, such as systems with Grubbs catalysts, and the like. Non-LED sources also include non-LED light sources, for example, a broad-spectrum halogen light, a laser and diffuser, sunlight, and the like.

In various embodiments, the at least one directional light source is turned off after the pre-gelation duration. In various embodiments, the cured image includes a smooth surface. In some embodiments, “surface smoothness” is described with respect to voxel resolution or a projector pixel-size. In some embodiments, such a “smooth surface” is a surface of a print wherein no distorted portion is greater than the minimum focused spot size of a single writing pixel. In some embodiments, a “smooth surface” is a surface of a print wherein no distorted portion is greater than the size of the smallest possible voxel (e.g., smallest feature) that can be patterned in a given application. Striations caused by self-written waveguides (SWWs) can be on a similar size scale (e.g., of the SWW's). For example, surface ripples that are 10 times smaller are not, in some embodiments, due to SWW's, whereas surface ripples that are in the 0.5 to 10 times range of a pixel size are, in some embodiments, due to SWW's. The “smoothness” of a surface can scale up or down with size or fidelity of a printer (e.g., printers with 1 cm-sized voxels, while micro-VAM printers with striations are in the nanometer range). In some embodiments, the smoothness of a surface (often termed surface roughness or roughness) can be measured according to the ISO 4287:1997 standard, for example by using the Rₐ roughness value (average of profile height deviations from the mean line). In various embodiments, the striation-free surfaces produced by the methods described herein have Rₐ values of less than or equal to about 0.8, 0.4, 0.2, 0.1, 0.05, or 0.025 μm.

In various embodiments, the cured image has a uniform refractive index. In such embodiments, the entire volume that is “in-part” (i.e., the volume desired to print) has a small variation in refractive index. In contrast, conventional VAM prints form striations with higher conversion at the centers of the striations, where higher conversion often corresponds with higher density, which often corresponds with a higher refractive index.

In various embodiments, the cured image has a uniform modulus, hardness, or other material property.

In various embodiments, a system for three-dimensional printing is provided. In certain embodiments, the system includes at least one directional light projector. In certain embodiments, the system includes at least one diffuse curing system. In certain embodiments, the diffuse curing system includes at least one of an angularly diffuse light source, a spatially diffuse light source, a chemical curing system, an ultrasound curing system, a vibrational curing system, an electrical energy curing system, an inductive energy curing system, or a thermal curing system. In certain embodiments, the system includes a control subsystem in electronic communication with the at least one directional light projector and the at least one diffuse curing system. In certain embodiments, the control subsystem is configured and adapted to irradiate a volume of photocurable resin with the at least one directional light projector for a pre-gelation duration. In certain embodiments, the control subsystem is configured and adapted to deliver energy to the volume of photocurable resin with at least one diffuse curing system.

In various embodiments, the at least one directional light projector includes a laser radiation system configured to provide laser radiation. In various embodiments, the at least one directional light projector includes a photocuring 3D printer. In various embodiments, the pre-gelation duration is a period sufficient to at least partially cure the photocurable resin with the directional light projector before gelation occurs. In various embodiments, the at least one diffuse curing system includes at least one of a LED source or a non-LED source.

In various embodiments, the control subsystem is configured to turn off the at least one directional light projector after the pre-gelation duration. The control system, in some embodiments, includes a timer that can be used to turn off the light projector after the pre-gelation duration.

Volumetric additive manufacturing (VAM) enables rapid printing into a wide range of materials, offering significant advantages over other printing technologies, with a lack of inherent layering of particular note. However, VAM suffers from striations, which are similar in appearance to layers; often on the order of print feature size; and similarly limiting on applications (due to mechanical and refractive index inhomogeneity, surface roughness, shape-accuracy, significant cosmetic defects, etc.). These striations are caused by a self-written waveguide effect, driven by the gelation material nonlinearity upon which VAM relies, and are not a direct recording of non-uniform patterning beams. Material nonlinearity also drives striations via a self-writing waveguide (SWW) effect. The present disclosure provides a simple and effective method of mitigating striations via a uniform optical exposure added to the end of a VAM printing process. Such a method may shorten the period from initial gelation to print completion, mitigating the problem of partially gelled parts sinking before print completion, and expanding the range of resins printable in any VAM printer.

VAM prints into a volume of photosensitive resin in a single lithographic step, and is thus free of inherent layering effects. After tens to hundreds of seconds of optical exposures, the desired geometry gels and is removed from the remaining liquid resin. Fundamental to this process is a material nonlinearity—a gelation threshold—which enables delivery of optical dose for selective gelation of the desired print volume without unwanted gelation of the surrounding resin. This approach has multiple advantages over multi-step AM (e.g., non-contiguous prints become possible; the lack of material movement during printing removes resin viscosity constraints, thus increasing the range of accessible material properties; print times are dramatically reduced and layering is fundamentally absent from the printing process; etc.).

### Striations In VAM

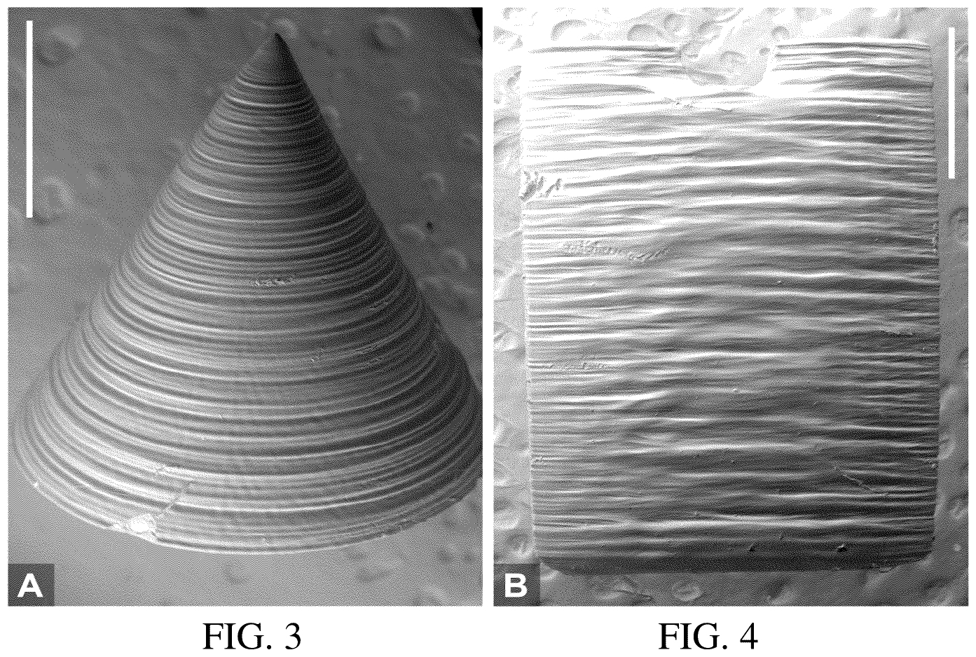

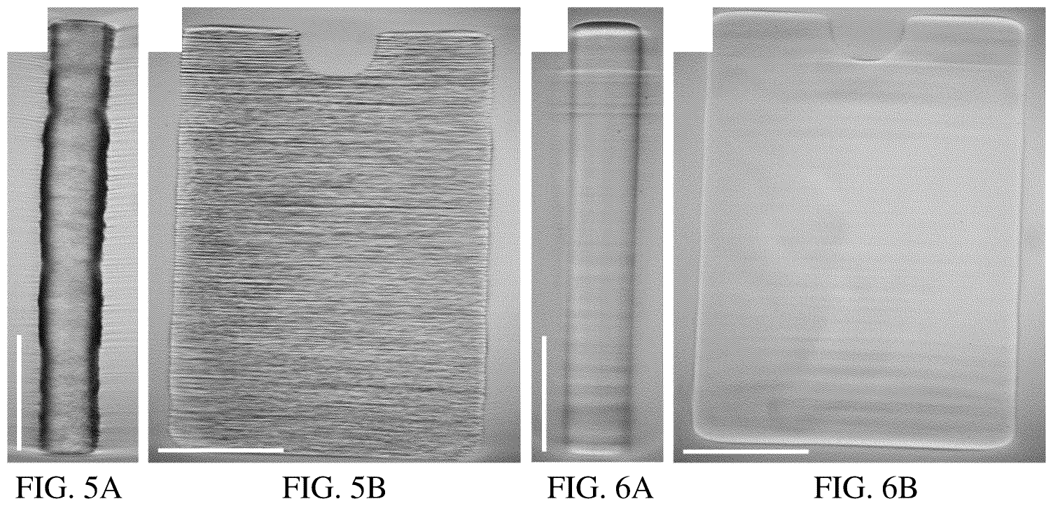

Striations are a prevalent problem in the field of VAM. A variety of volumetric printers applied to a wide range of materials suffer from large striations on the order of feature size. Such striations not only degrade print-shape accuracy, but any non-uniformities in polymer conversion can manifest as inhomogeneity or anisotropy of modulus, or as unwanted refractive index variability. Thus, although VAM is free from “layering,” it is not free from layer-like effects. Examples of typical VAM striations are shown in FIG. 3, FIG. 4, and FIGS. 5A-5B.

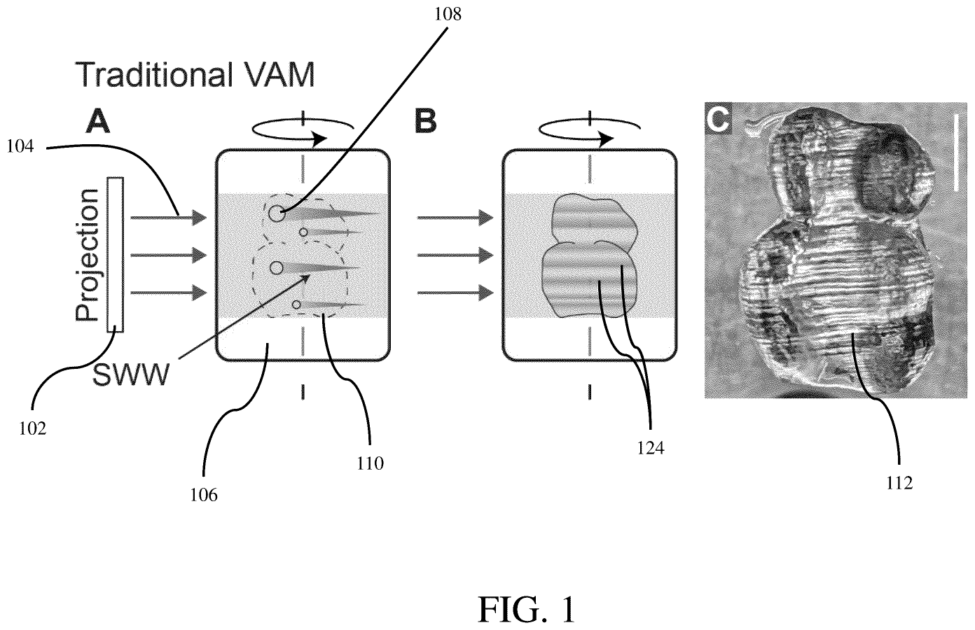

Referring now to FIG. 1, a traditional VAM process is illustrated. A directional light source 102 is illustrated projecting optical energy 102 (e.g., light, laser, etc.) to photocurable resin 106 to create the geometry 110 of a final printed part 112. Material nonlinearity of photocurable resin 106 drives striations 124 via a SWW effect. Here, optical energy 104 (e.g., light) gels a small region of material forming gelled region 108 (or a plurality of gelled regions 108). The refractive index of gelled region 108 changes (e.g., increases relative to the refractive index of photocurable resin 106) as a result of the phase change. Consequently, gelled region 108 acts as a lens, concentrating optical energy 102 (e.g., light) to the resin just beyond it. The increased intensity causes this next region to also gel more quickly than the surrounding resin 106 (e.g., uncured resin). This effect continues with each new region of gelation building upon the growing waveguide until a long waveguide (e.g., a striation of increased index) extends through the print region. Depending on material index-change dynamics and on the intensity profile of writing beams, SWW's can form with variable widths (e.g., not matching the size of the writing beams). SWW's can be unstable in their propagation direction, and filamentation can also occur, with stochastic splitting and merging behavior.

The SWW effect is most pronounced when the refractive index of the material changes most quickly with conversion (i.e., during the gelation phase change). The much smaller index change of pre-gelation conversion also produces SWW's, as perhaps seen in the liquid resin surrounding the prints (e.g., see FIGS. 5A, 6A, 9A, and 9B). However, their smaller index change may have a negligible impact (e.g., as evidenced by striation-free prints illustrated in the drawings). Prominent print striations are expected only when highly directional illumination (e.g., VAM patterning beams) are incident on a material near the start of gelation. Thus, avoiding directional illumination as the material gels greatly reduces striations in VAM prints.

In various embodiments, the latent cure method detailed herein effectively suppresses striations. In some embodiments, about 85-95% of the printing dose is delivered by patterned writing beams before gelation, and then the final 5-10% of dose is delivered by a uniform exposure (e.g., flood cure). In various embodiments, about 85, 86, 87, 88, 89, 90, 91, 92, 93, 94, or 95% of the printing dose is delivered by patterned writing beams before gelation. In various embodiments, 90% of the printing dose is delivered by patterned writing beams before gelation. In some embodiments, about 30% of the printing dose is delivered by patterned writing beams before gelation, and then the final 70% of dose is delivered by a uniform exposure (e.g., flood cure). In various embodiments, about 25, 26, 27, 28, 29, 30, 31, 32, 33, 34 or 35% of the printing dose is delivered by patterned writing beams before gelation. In various embodiments, 30% of the printing dose is delivered by patterned writing beams before gelation. Of course, various ranges of the printing doses are contemplated (e.g., 25%-95%) as are the ranges of the final dose (e.g., 5-75%). Printing doses as low as 2% and final doses of 98% are similarly contemplated.

VAM striations are not merely a direct recording of the writing beams. If striations were simply a direct recording of non-uniform beams, one would expect to see them develop along with the rest of the part during latent cure. Striation visibility would likely be reduced by the uniform exposure, but only by a small amount. Instead, surprisingly and unexpectedly, a nearly complete elimination of striations may be observed. Without being bound by theory, this observation suggests a fundamental difference between using highly directional patterned illumination and an angularly-diffuse flood exposure to cross the gelation threshold.

### Latent Cure Method

Certain embodiments of the present disclosure are now described with reference to the following Examples. These Examples are provided for the purpose of illustration only, and the disclosure is not limited to these Examples, but rather encompasses all variations that are evident as a result of the teachings provided herein.

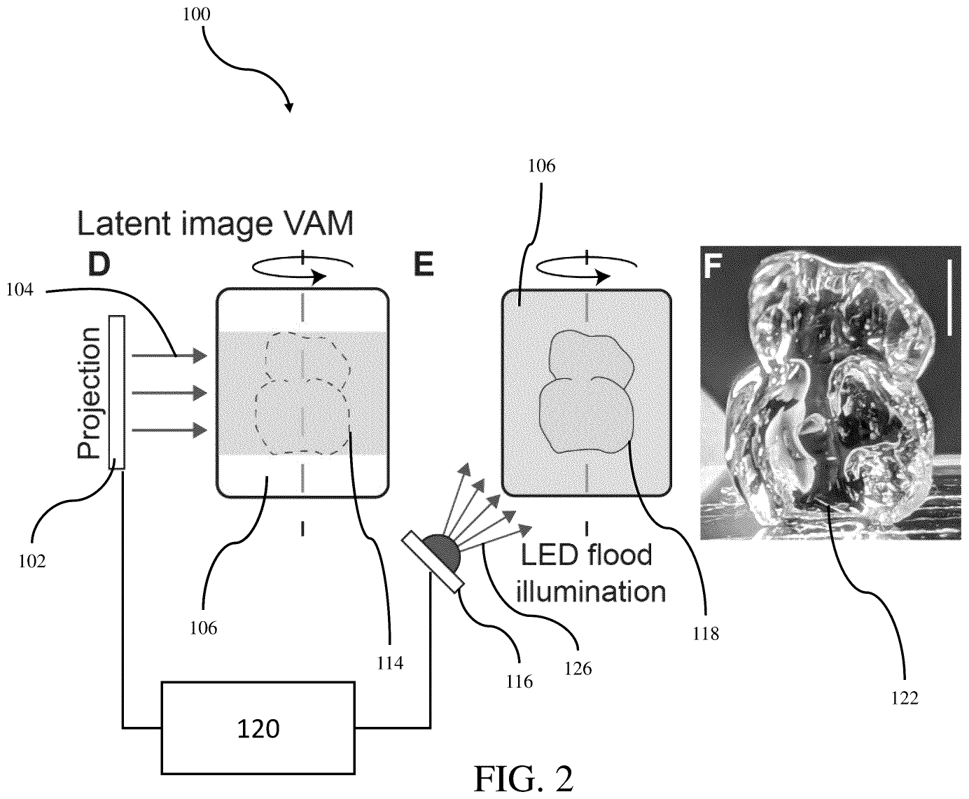

Referring now to FIG. 2, a system 100 for three-dimensional printing is illustrated, in accordance with certain embodiments of the present disclosure. System 100 includes at least one directional light projector 102 (e.g., an optical projector, a laser-based projector, an LED-based projector, a projector using a Mercury lamp, a laser system, a light projection system, a stereolithographic projector, etc.). Directional light projector 102 can include a light source (e.g., a photon source, a laser, LED, lamps, etc.). Directional light projector 102 can include a pattern generator (e.g., digital micromirror device (DMD), spatial light modulator (SLM), liquid crystal display (LCD) technology, amplitude mask, etc.). Directional light projector 102 can include optical subcomponents (e.g., a light homogenization system, fiber optics that manipulate light for a pattern generator, lenses/prisms/mirrors for focusing and routing light from photon-source to a pattern generator, optical elements to image from the pattern generator to the printing sample, etc.) Directional light projector 102 is configured to provide energy (e.g., irradiate, provide optical energy, provide light, provide a laser, provide radiation, provide a stimulus, etc.) to a volume of at least one photocurable resin 106 (e.g., a photosensitive material; a photocurable liquid resin or gel; a holographic photopolymer; etc.) for at least a portion of a pre-gelation duration to form a latent image 114. In certain embodiments, the (at least one) directional light projector 102 includes a laser radiation system configured to provide laser radiation; in such an embodiment, directional light projector 102 may “write” or selectively alter material (e.g., photocurable resin, photocurable liquid resin, etc.) using laser radiation (e.g., partially cure without changing phases, “write” the geometry of the final printed part, etc.). In certain embodiments, the (at least one) directional light projector 102 includes a photocuring 3D printer (e.g., LED-based CAL printer; DLI 3DLP9000 UV retrofitted with a telecentric lens; LED-based CAL printer with a peak print-plane intensity of 65 mW/cm²; a printer with a 3W, 405 nm laser, a square-core fiber for light homogenization, and a ViALUX V-9001 digital micromirror device (DMD); an so forth).

System 100 also includes at least one diffuse curing system 116. Diffuse curing system 116 is configured to deliver energy (e.g., optical energy, thermal energy, chemical energy, ultrasound energy, etc.) to a curable resin. Diffuse curing system 116 may include at least one of an angularly diffuse light source, a spatially diffuse light source, a chemical curing system, an ultrasound curing system, a vibrational curing system, an electrical energy curing system, an inductive energy curing system, or a thermal curing system. Some examples of diffuse curing system 116 may include a highpower LED (e.g., SOLIS-405C-High-Power LED), a projector with a light scattering apparatus, a system using a large integrating sphere, a system using ultrasound, a chemistry oven, a heat gun, etc. Diffuse curing system 116 is configured to deliver energy (e.g., flood irradiate) to the volume of photocurable resin 106 to cure latent image 114 and form a cured image 118. In certain embodiments, the (at least one) diffuse curing system 116 includes a LED source or a non-LED source (or both).

System 100 also includes a control subsystem 120 in electronic communication with the at least one directional light projector 102 and the at least one diffuse curing system 116. Control subsystem 120 is configured and adapted to i) irradiate the volume of photocurable resin 106 with the at least one directional light projector 102 for a pre-gelation duration; and ii) deliver energy (e.g., flood irradiate) to the volume of photocurable resin 106 with (at least one) diffuse curing system 116. In certain embodiments, the pre-gelation duration is a period sufficient to at least partially cure the photocurable resin 106 with directional light projector 102 before gelation occurs. In certain embodiments, control subsystem 120 is configured to turn off the (at least one) directional light projector 102 after the pre-gelation duration.

FIG. 2 also illustrates a method of three-dimensional (3D) printing. The method includes the step of irradiating a volume of at least one photocurable resin 106 with at least one directional light projector 102 for at least a portion of a pre-gelation duration to form a latent image 114. The method also includes the step of providing energy (e.g., flood irradiating) to the volume of (at least one) photocurable resin 106 with (at least one) diffuse curing system 116 to cure latent image 114 and form a cured image 118, the diffuse curing system 116 including at least one of an angularly diffuse light source, a spatially diffuse light source, a chemical curing system, an ultrasound curing system, a vibrational curing system, an electrical energy curing system, an inductive energy curing system, or a thermal curing system, wherein cured image 118 has reduced striations (e.g., see the final printed part 122). In certain embodiments or applications, final printed part 122 or cured image 118 has no striations (i.e., the striations in cured image 118 are absent) or the striations are mitigated. The cured image may include a smooth surface (e.g., the outermost surface area) or a uniform refractive index (or both).

In certain embodiments, the (at least one) directional light projector 102 includes (at least one) LED source or a laser radiation source (or both). In certain embodiments, the (at least one) directional light projector 102 includes a photocuring 3D printer (e.g., LED-based computed axial lithography (CAL) printer; DLI 3DLP9000 UV retrofitted with a telecentric lens; LED-based CAL printer with a peak print-plane intensity of 65 mW/cm², etc). In certain embodiments, the pre-gelation duration is a period sufficient to at least partially cure the photocurable resin 106 with directional light projector 102 before gelation occurs. In certain embodiments, the (at least one) directional light projector 102 is turned off after the pre-gelation duration.

In certain embodiments, a plurality of angularly diffuse light sources are used. In certain embodiments, the (at least one) diffuse curing system 116 includes at least one light diffuser. In certain embodiments, the (at least one) diffuse curing system 116 includes (at least one of) a LED source or a non-LED source (or both).

By using diffuse light instead of highly directly patterning beams to cross the material nonlinearity, the method of the present disclosure avoids, mitigates, prevents, or eliminates striations in the printed object. As illustrated in FIG. 2, a print starts (e.g., similar to a traditional VAM process) with patterned illumination locally increasing polymer conversion in the resin (see the section marked “D”). Just before gelation is reached, the writing is stopped, leaving a latent image 114 of the desired print in the form of higher polymer conversion and oxygen depletion for the desired in-part regions than the surrounding out-of-part regions. Then, a diffuse curing system 116 (e.g., an LED with a diffuser) applies a low-spatial-coherence, uniform exposure to the entire volume of resin 106 such that the exposure (e.g., light 126, stimulus, etc.) is incident from a wide range of angles (see the section marked “E” of FIG. 2). This develops latent image 114 into a gelled part (e.g., cured image 118).

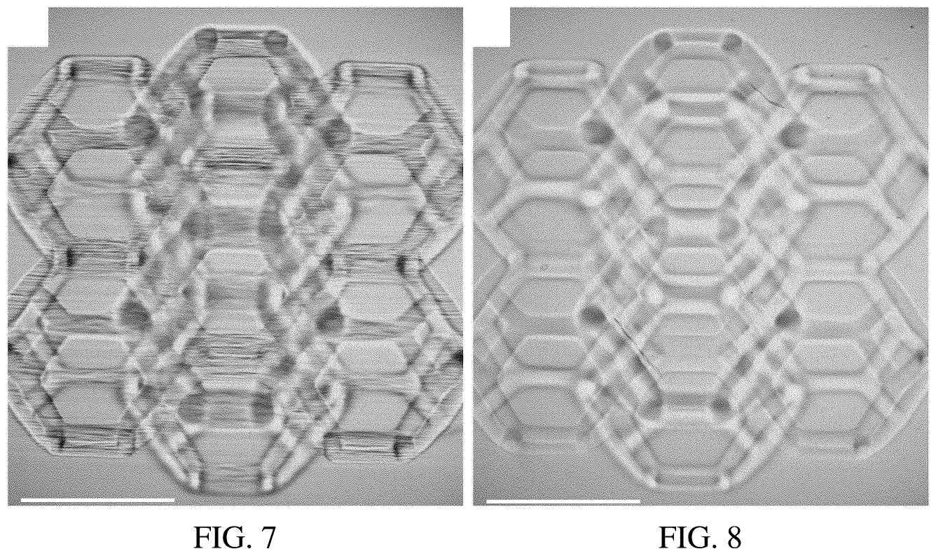

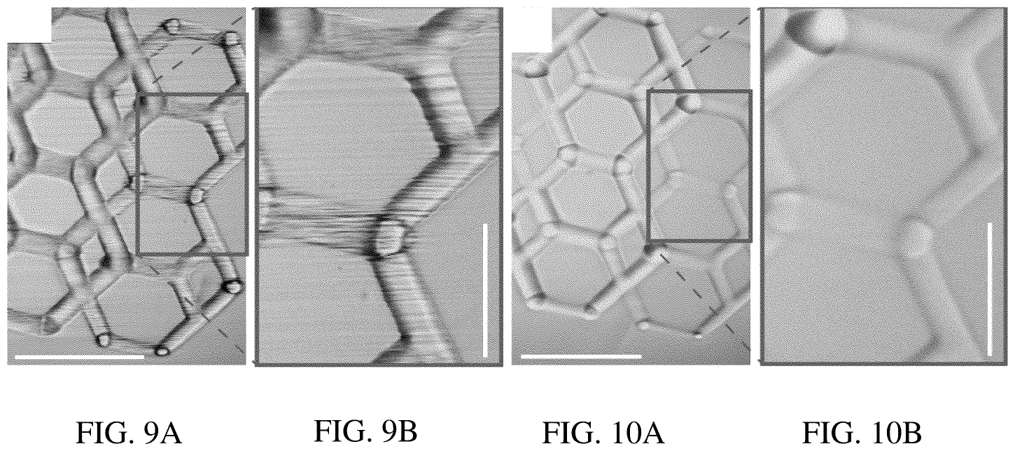

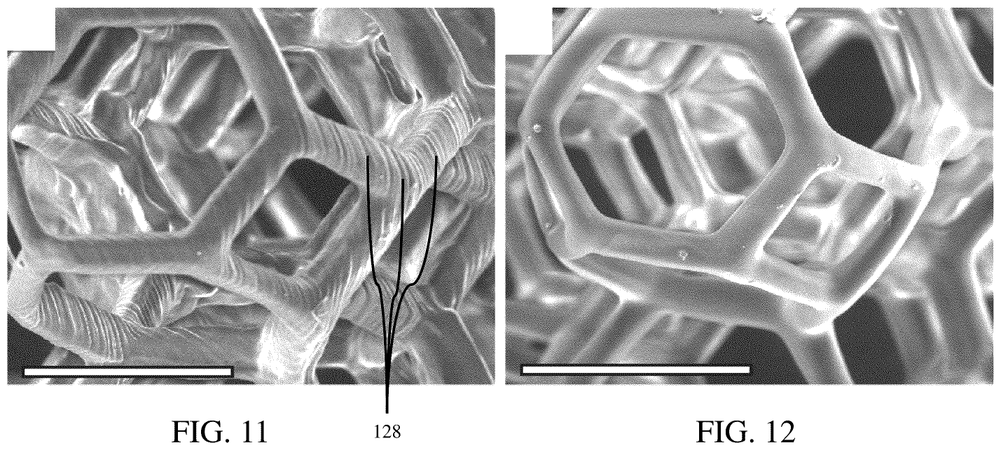

The energy application (e.g., flood irradiation, flood illumination, etc.) is ceased before unwanted gelation occurs in the surrounding out-of-part regions, thus preserving selective gelation. In certain applications, patterning illumination can be stopped just before any gelation occurs. In many applications, stopping the print slightly earlier or slightly after the first sign of gelation on a shadowgram produces acceptable results (e.g., little or no striation). The difference in resulting striation reduction (or elimination) of the final printed part is clearly exhibited between final printed part 122 of FIG. 2 (produced by a method of the present disclosure) and final printed part 112 of FIG. 1 (produced by a traditional VAM process). Further, the difference in resulting striation reduction (or elimination) is clearly exhibited in contrasting FIGS. 6A-6B with FIGS. 5A-5B; FIG. 8 with FIG. 7; FIGS. 10A-10B with FIGS. 9A-9B; and FIG. 12 with FIG. 11.

The shadowgrams of FIG. 3, FIG. 4, FIGS. 5A-5B, FIGS. 6A-6B, FIG. 7, FIG. 8, FIGS. 9A-9B, and FIGS. 10A-10B highlight even small refractive index changes suggesting improved uniformity (although measurements without the surrounding resin in place would be more thorough). Surface striation effects are eliminated (or greatly reduced) as shown via SEM scans in FIG. 12 (as compared to surface striations 128 of FIG. 11). The uniform exposure decreases the dose-contrast between in-part and out-of-part regions, reducing system error tolerances, but only by a small fraction equal to the in-part dose range of the tomographic reconstruction (e.g., about 10% for typical prints). In an idealized environment, a VAM print (e.g., one free of missing or unwanted gelled voxels) will remain so upon latent cure. Certain embodiments of the present disclosure (e.g., a latent cure method) use an LED and diffuser to provide final prints with greatly reduced or eliminated striations. In certain other embodiments of the present disclosure, the non-directionality of the latent cure can be improved via multiple light sources, an integrating sphere around the print, or another modification to increase the range of input angles over which the floor irradiation (e.g., flood exposure) is delivered.

Although the flood irradiation illustrated uses light 126 (e.g., from an LED or non-LED source), the disclosure is not so limited. Thermal energy, chemical energy, irradiative energy, vibrational energy, ultrasound energy, inductive energy (e.g., if metal particles were added to the resin), optical energy, or another stimulus which affects a resin (or other material used in a 3D printing application) in a diffuse or distributed manner is contemplated and disclosed in the present disclosure.

### EXAMPLES

Various embodiments of the present application can be better understood by reference to the following Examples which are offered by way of illustration. The scope of the present application is not limited to the Examples given herein.

### Materials and Methods

The prints shown in FIGS. 1-2 were made on a laser-based printer with a peak print-plane intensity of 550 mW/cm² at a wavelength of 405 nm. The resin used was a 3:1 mixture of Bisphenol A glycerolate (1 glycerol/phenol) diacrylate and Poly (ethylene glycol) diacrylate (Mₙ 250). The photo-initiator used was Irgacure 907 at 80 mM and 20 mM concentrations for the conventional and latent VAM prints, respectively. For the conventional VAM print of FIG. 1 (section marked “C”), the print time was 48 seconds. For the latent cure print of FIG. 2 (section marked “C”), patterned illumination was incident for 77 seconds at which point, a few small portions of the part had started to gel. Then 405 nm uniform illumination was applied for 10 seconds with an LED with a diffuser, completing the print. The latent print was slower than the conventional print, since it only had a quarter of the initiator concentration. The LED intensity was approximately 1.5 W/cm², however, it was incident on the corner of an index-matching bath, refracting towards the print from multiple directions. Thus, the flood-cure intensity received by the print could have been as much as double the LED intensity and the flood source was applied until print completion, as observed on a shadowgram.

Prints shown in FIG. 3 through FIG. 12 were made on a laser-based printer with peak print-plane intensity of 204 mW/cm² at a wavelength of 442 nm. The resin used in these figures is pentaerythritol tetraacrylate with 10 mM camphorquinone photoinitiator. An equal mass of ethyl 4-(dimethylamino) benzoate (to camphorquinone) is added to this resin. In FIG. 3, the cone was made by conventional VAM and the patterned illumination was incident for 55 seconds. In FIG. 4, the slab was made by conventional VAM and patterned illumination was incident for 55 and 60 seconds, respectively. The slab (of FIGS. 6A-6B) and lattice (of FIG. 8, FIGS. 10A-10B, and FIG. 12) were made by latent image VAM and the patterned illumination was incident for 23 and 30 seconds, respectively. In each of FIGS. 6A-6B, FIG. 8, FIGS. 10A-10B, and FIG. 12, a 455 nm uniform LED illumination was applied for 10 seconds to complete the printed part. LED intensity at the print plane was approximately 40 mW/cm².

### Example 1: Latent Cure to Avoid Partial-Print Sinking

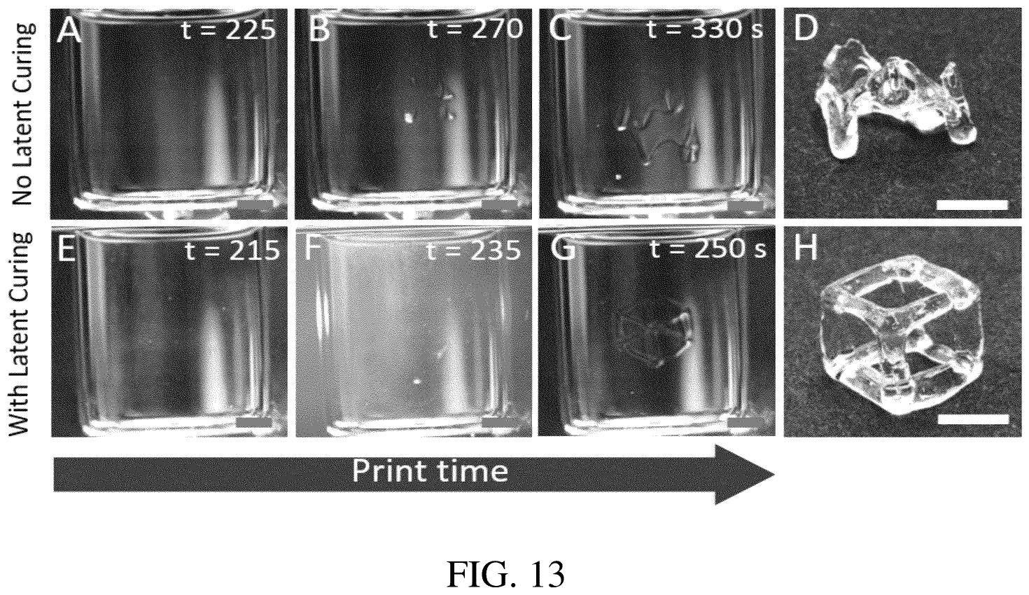

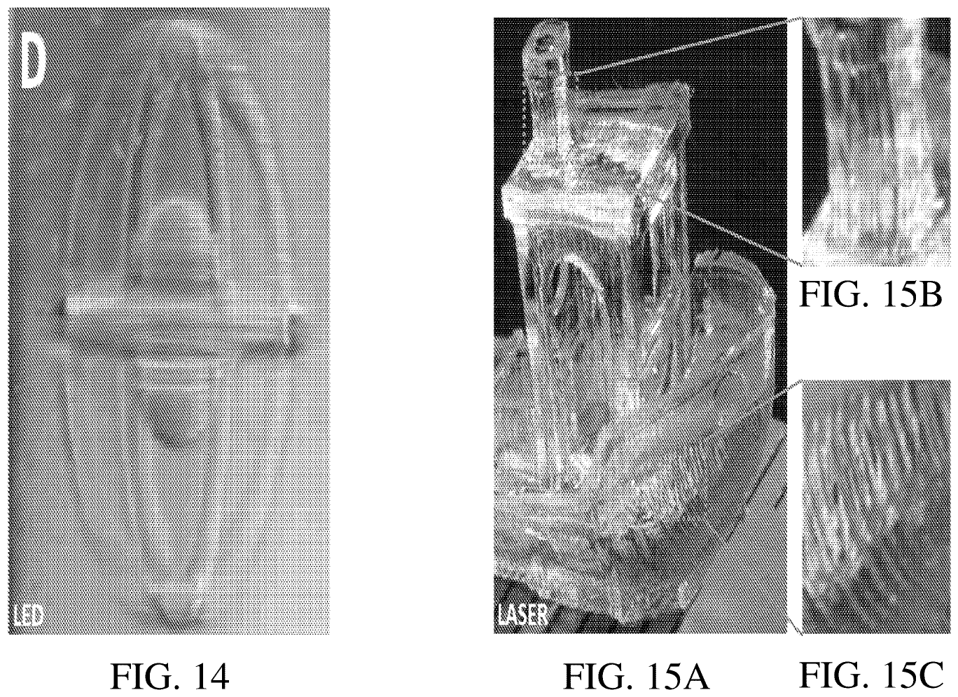

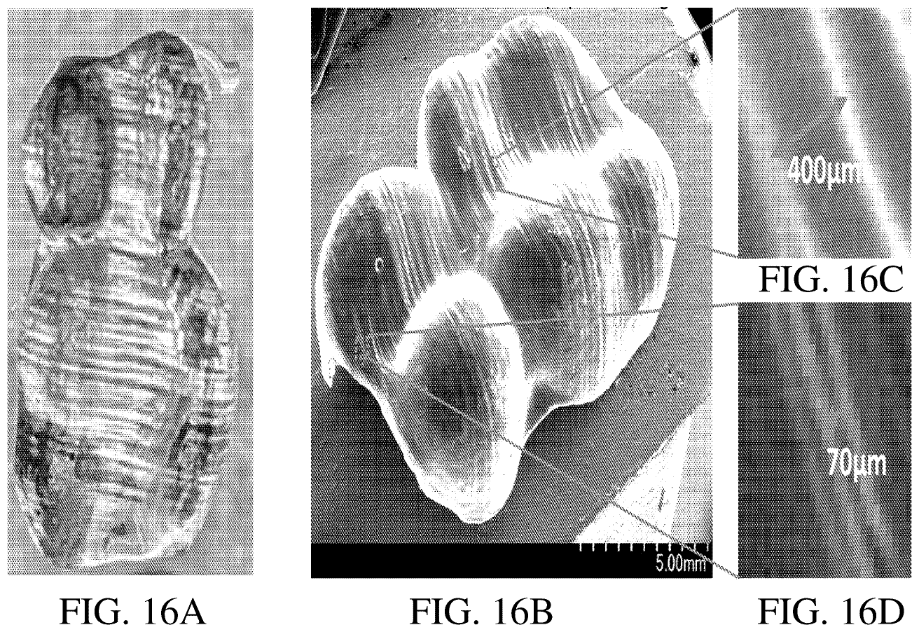

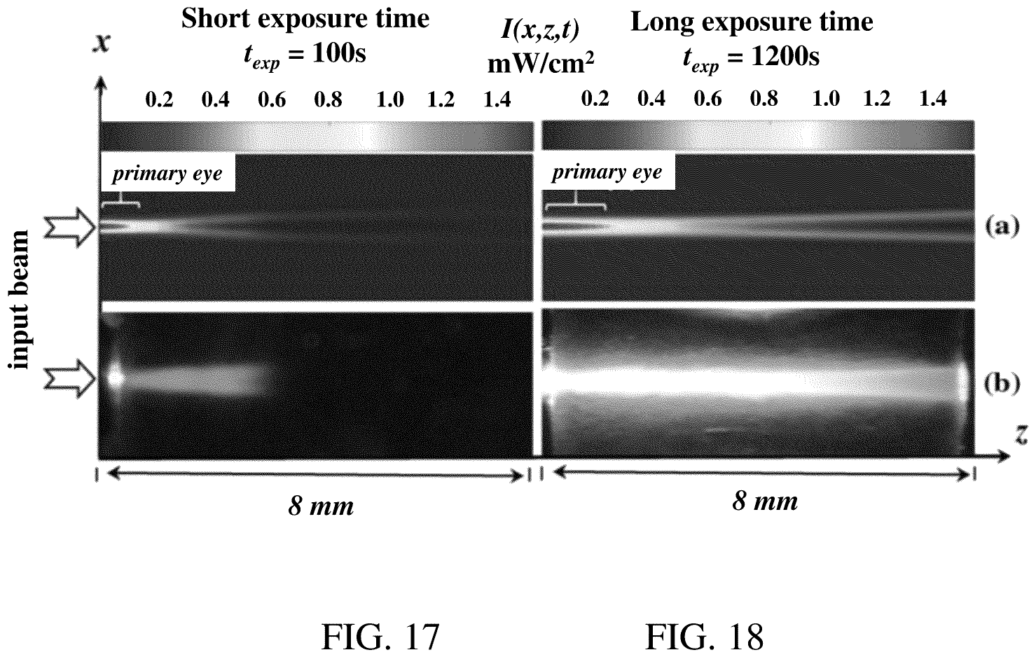

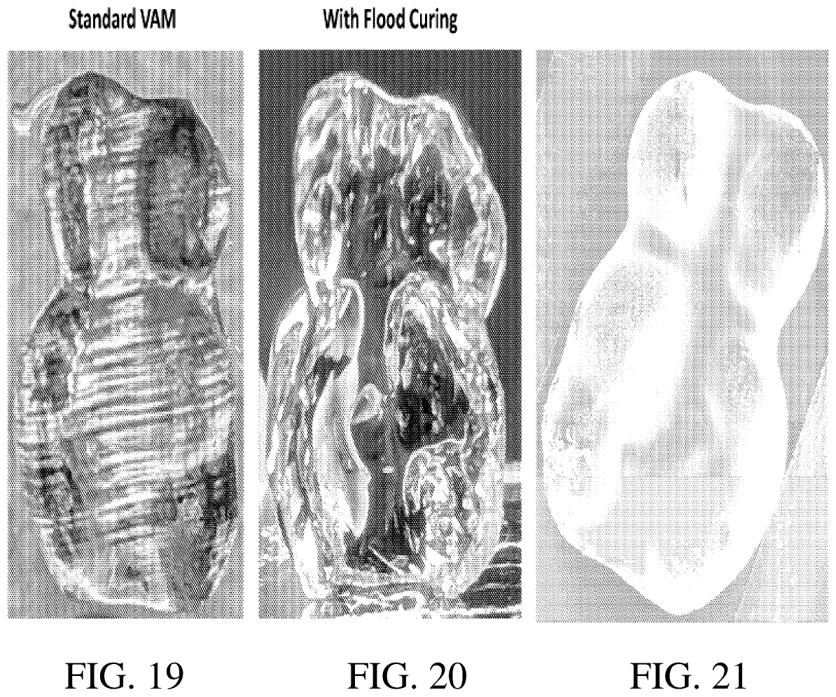

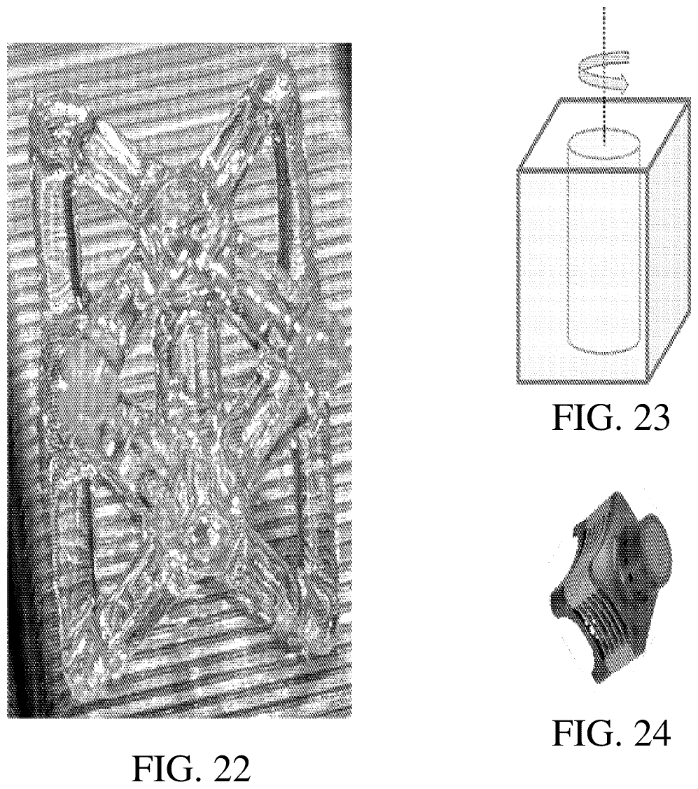

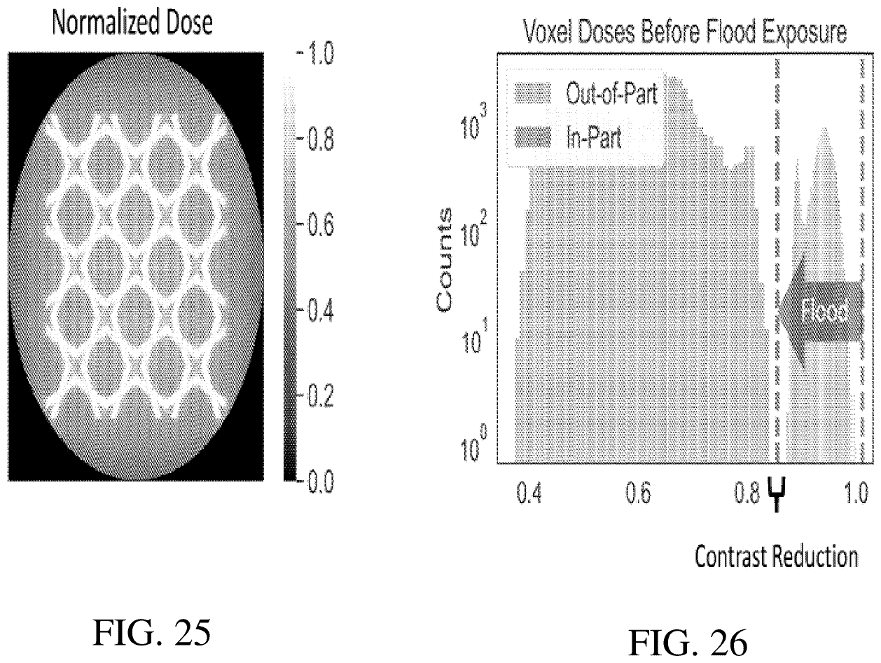

The latent cure step also serves as an opportunity to apply high intensity optical exposure during the GP of a print. This step can dramatically shorten the GP, ameliorating the distortion of a print due to partial part sinking during printing. This effect occurs when the polymerization rate is slow relative to the settling velocity of the gelled material, as is the case for systems with low print power, low viscosity resins, or large change in the density upon gelation. An inexpensive latent cure source, free of the etendue requirements that practically limit patterned print power, can be added to any VAM system to expand the range of materials that it can accurately print. This could allow low-power VAM printers to use resins previously only accessible by costly, high-power systems, just as it could allow state of the art, high-power printers access to a new range of resins. FIG. 13 shows an example of how latent cure may enable printing in a low viscosity (<1 Pa·s) resin that would otherwise be untenable, given printer-power.

Like the layering effects that limit the applications of typical 3D printing methods, striations in VAM may cause non-uniformity in modulus and refractive index, and degrade print-surface accuracy. Striations are not simply recorded writing beams, and are instead caused by a SWW effect (driven by the material nonlinearity of VAM. Striations can be avoided by adding a diffuse latent-cure step, improving uniformity of a final printed part. The non-directionality of the latent cure could be improved by an array of lamps, by a surrounding integrating sphere, etc., improving the uniformity of the method, and minimizing the SWW effect.

### Example 2: Contrast Reduction Upon Latent Cure

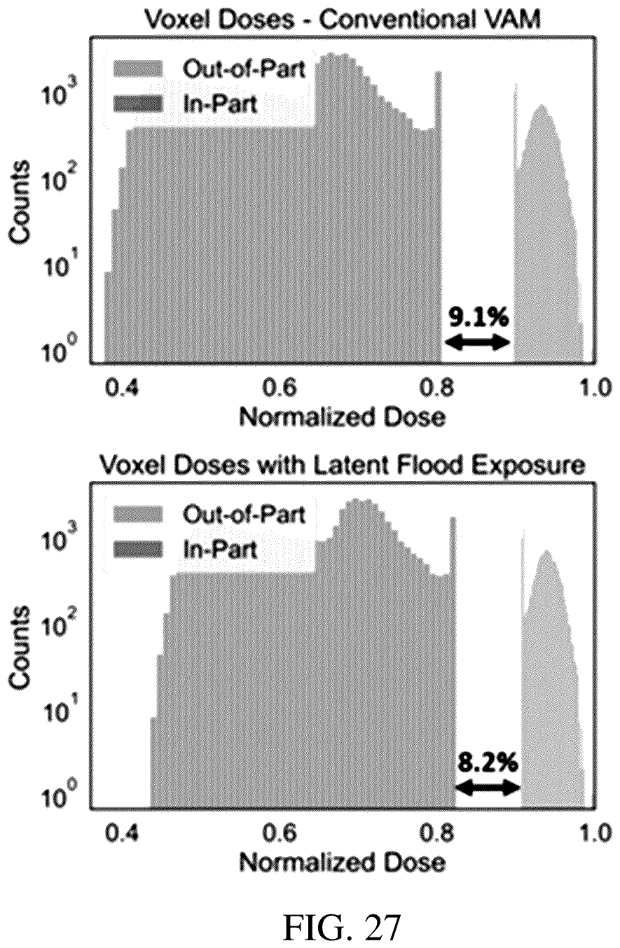

The uniform latent cure flood exposure adds optical dose to both the in-part and out-of-part resin regions. This reduces the contrast between these regions, but only by a percentage equal to the in-part dose range. FIG. 27 shows an example of a tomographic dose distribution with and without a latent cure. Thus, for the simple case of a positive process window with ideal materials (e.g., with a well-defined nonlinearity, no dark-polymerization, etc.), no degradation of print-accuracy is expected upon latent cure.

In the case of a tomographic reconstruction unable to achieve a voxel error rate of zero (i.e., one that would produce error voxels), the addition of a latent cure would further degrade the print. That is, in the case of a reconstruction where the in-part and out-of-part histograms overlap, adding a latent cure exposure will further that overlap, thus increasing the number of error voxels regardless of where the gelation threshold is set.

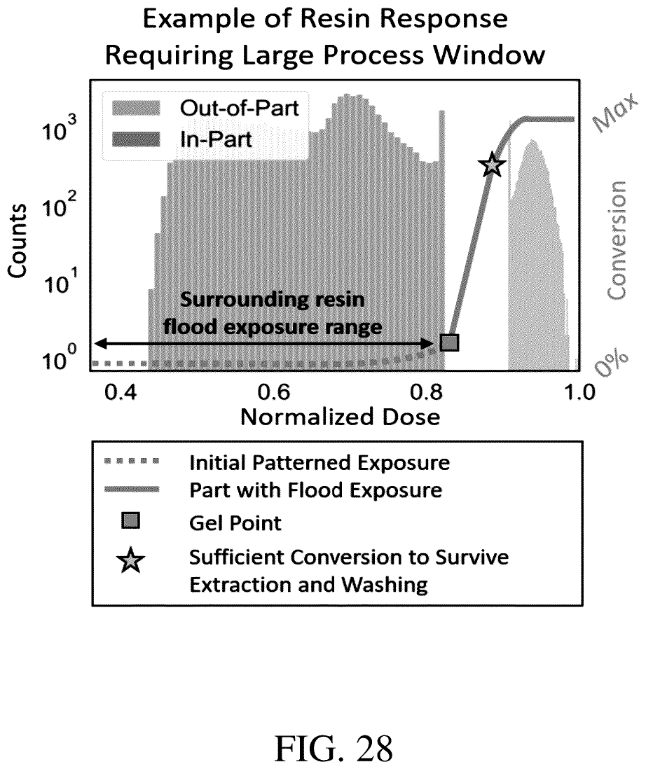

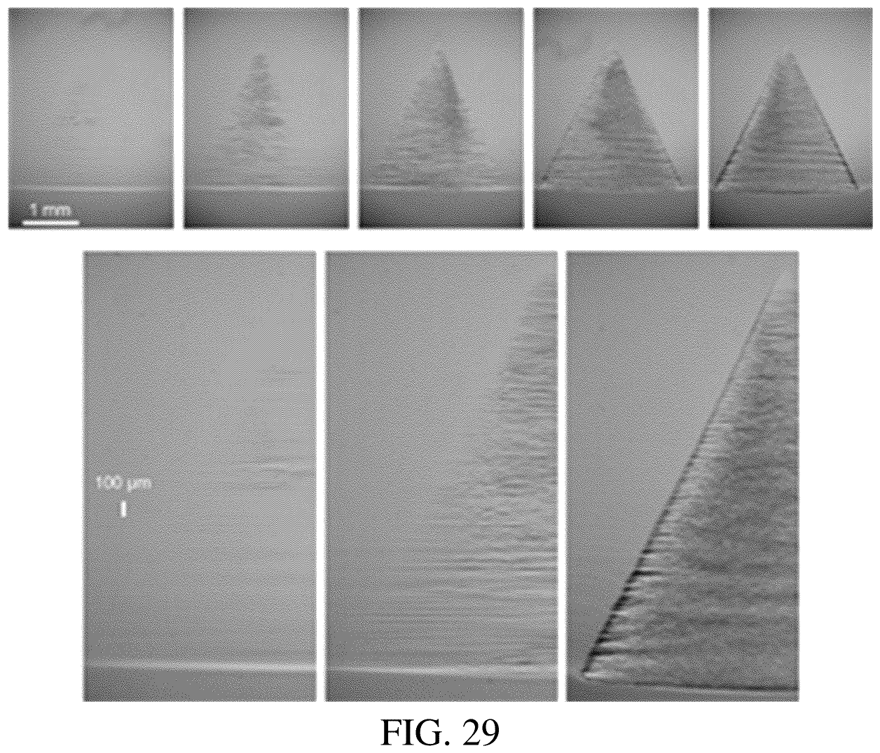

It can be the case that a small positive process window is insufficient for avoiding gelation errors. This can be due to the process window being taken up by timing or other experimental errors. However, even under otherwise ideal conditions, the resin curing dynamics may require not only a positive process window, but one of at least a certain size. For example, a material may be mechanically weak upon initial gelation and may not survive removal and washing without breaking or deforming. To print such a resin, it is necessary to drive the in-part regions of a print beyond gelation, to a degree of conversion yielding sufficient strength. The additional optical exposure required to do this also increases optical dose for the out-of-part regions. If the process window is positive but very small, the dose required to sufficiently cure in-part voxels beyond gelation can also cause gelation in out-of-part voxels. Thus, some materials require a minimum process window size to be printable without gelation errors. An example of such a resin response is illustrated in FIG. 28.

Printing without gelation errors can require a positive process window of a minimum size. This can allow for system errors in timing, optical non-uniformity, etc. This can also allow for curing in-part regions beyond gelation without any unwanted gelation in out-of-part regions. Thus, for the latent cure step to introduce no print-shape errors, the final reduced process window size must still be sufficient given the constrains of the entire printing process.

### Example 3: Timing VAM Prints for Latent Cure

When using the latent cure method, patterning illumination is ideally stopped just before any gelation occurs. In practice, stopping the print slightly earlier or later still produces acceptable results (e.g., final printed parts with little or no striations).

If the print is stopped well before gelation (as compared to the last moment before gelation), the contrast of the final dose-reconstruction will be reduced. This is because a larger latent-cure dose will then be required to bring the part to gelation. Adding a larger uniform dose to a smaller reconstruction patterned dose distribution will reduce the final contrast of the reconstruction. However, as long as the reconstruction process window is positive (as shown in FIG. 27), the final reconstruction will still have a positive process window, and thus will produce a theoretically perfectly-gelled part. A smaller process window, however, will leave less room for tolerating system errors while maintaining correct gelation, as discussed herein.

A print can also be stopped late, after some gelation within the print region has occurred. In this case, one may expect that any such gelation would cause striations via the SWW effect. However, in practice when only a small percentage of the part gels before the print is stopped, a latent cure still produces a print free of noticeable striations. Thus, the first signs of gelation during a print may be used as a signal to stop the print, avoiding the need for careful control over print timing.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### Enumerated Embodiments

The following enumerated embodiments are provided, the numbering of which is not to be construed as designating levels of importance:

Embodiment 1 provides a method of three-dimensional (3D) printing. In certain embodiments, the method comprises i) irradiating a volume of at least one photocurable resin with at least one directional light projector for at least a portion of a pre-gelation duration to form a latent image. In certain embodiments, the method comprises ii) delivering energy to the volume of the at least one photocurable resin with at least one diffuse curing system to cure the latent image and form a cured image. In certain embodiments, the diffuse curing system includes at least one of an angularly diffuse light source, a spatially diffuse light source, a chemical curing system, an ultrasound curing system, a vibrational curing system, an electrical energy curing system, an inductive energy curing system, or a thermal curing system. In certain embodiments, the cured image has reduced striations.

Embodiment 2 provides the method of embodiment 1, wherein the at least one directional light projector comprises at least one of a photon source, a LED source, a lamp, or a laser radiation source.

Embodiment 3 provides the method of any one of embodiments 1-2, wherein the at least one directional light projector comprises a photocuring 3D printer.

Embodiment 4 provides the method of any one of embodiments 1-3, wherein the pre-gelation duration is a period sufficient to at least partially cure the photocurable resin with the directional light projector before gelation occurs.

Embodiment 5 provides the method of any one of embodiments 1-4, wherein a plurality of angularly diffuse light sources are used to cure the latent image and form the cured image.

Embodiment 6 provides the method of any one of embodiments 1-5, wherein striations in the cured image are absent or mitigated.

Embodiment 7 provides the method of any one of embodiments 1-6, wherein the at least one diffuse curing system comprises at least one light diffuser.

Embodiment 8 provides the method of any one of embodiments 1-7, wherein the at least one diffuse curing system comprises at least one of a LED source or a non-LED source. Embodiment 9 provides the method of any one of embodiments 1-8, further comprising the step of iii) stopping the irradiating of step i after the pre-gelation duration, wherein step iii occurs after step i.

Embodiment 10 provides the method of any one of embodiments 1-9, wherein the cured image comprises a smooth surface.

Embodiment 11 provides the method of any one of embodiments 1-10, wherein the cured image has a uniform refractive index.

Embodiment 12 provides a system for three-dimensional printing. In certain embodiments, the system comprises at least one directional light projector. In certain embodiments, the system comprises at least one diffuse curing system. In certain embodiments, the diffuse curing system includes at least one of an angularly diffuse light source, a spatially diffuse light source, a chemical curing system, an ultrasound curing system, a vibrational curing system, an electrical energy curing system, an inductive energy curing system, or a thermal curing system. In certain embodiments, the system comprises a control subsystem in electronic communication with the at least one directional light source and the at least one diffuse curing system. In certain embodiments, the control subsystem is configured and adapted to: irradiate a volume of photocurable resin with the at least one directional light source for a pre-gelation duration. In certain embodiments, the control subsystem is configured and adapted to: deliver energy to the volume of photocurable resin with at least one diffuse curing system.

Embodiment 13 provides the system of embodiment 12, wherein the at least one directional light projector comprises a laser radiation system configured to provide laser radiation.

Embodiment 14 provides the system of any one of embodiments 12-13, wherein the at least one directional light projector comprises a photocuring 3D printer.

Embodiment 15 provides the system of any one of embodiments 12-14, wherein the pre-gelation duration is a period sufficient to at least partially cure the photocurable resin with the directional light projector before gelation occurs.

Embodiment 16 provides the system of any one of embodiments 12-15, wherein the at least one diffuse curing system comprises at least one of a photon source, a LED source, a lamp, or a non-LED source.

Embodiment 17 provides the system of any one of embodiments 12-16, wherein the control subsystem is configured to stop the at least one directional light projector from irradiating the volume of photocurable resin after the pre-gelation duration.

What is claimed is:

1. A method of three-dimensional (3D) printing, the method comprising the steps of:
i) irradiating a volume of at least one photocurable resin with at least one directional light projector for at least a portion of a pre-gelation duration to form a latent image; and
ii) delivering energy to the volume of the at least one photocurable resin with at least one diffuse curing system to cure the latent image and form a cured image, the diffuse curing system including at least one of an angularly diffuse light source, a spatially diffuse light source, a chemical curing system, an ultrasound curing system, a vibrational curing system, an electrical energy curing system, an inductive energy curing system, or a thermal curing system, and
wherein the cured image has reduced striations.

2. The method of claim 1, wherein the at least one directional light projector comprises at least one of a photon source, a LED source, a lamp, or a laser radiation source.

3. The method of claim 1, wherein the at least one directional light projector comprises a photocuring 3D printer.

4. The method of claim 1, wherein the pre-gelation duration is a period sufficient to at least partially cure the photocurable resin with the directional light projector before gelation occurs.

5. The method of claim 4, wherein a plurality of angularly diffuse light sources are used to cure the latent image and form the cured image.

6. The method of claim 1, wherein striations in the cured image are absent or mitigated.

7. The method of claim 1, wherein the at least one diffuse curing system comprises at least one light diffuser.

8. The method of claim 1, wherein the at least one diffuse curing system comprises at least one of a LED source or a non-LED source.

9. The method of claim 1, further comprising the step of:
iii) stopping the irradiating of step i after the pre-gelation duration,
wherein step iii occurs after step i.

10. The method of claim 1, wherein the cured image comprises a smooth surface.

11. The method of claim 1, wherein the cured image has a uniform refractive index.

12. A system for three-dimensional printing, comprising:
at least one directional light projector;
at least one diffuse curing system, the diffuse curing system including at least one of an angularly diffuse light source, a spatially diffuse light source, a chemical curing system, an ultrasound curing system, a vibrational curing system, an electrical energy curing system, an inductive energy curing system, or a thermal curing system;
a control subsystem in electronic communication with the at least one directional light source and the at least one diffuse curing system, wherein the control subsystem is configured and adapted to:
irradiate a volume of photocurable resin with the at least one directional light source for a pre-gelation duration; and
deliver energy to the volume of photocurable resin with at least one diffuse curing system.

13. The system of claim 12, wherein the at least one directional light projector comprises a laser radiation system configured to provide laser radiation.

14. The system of claim 12, wherein the at least one directional light projector comprises a photocuring 3D printer.

15. The system of claim 12, wherein the pre-gelation duration is a period sufficient to at least partially cure the photocurable resin with the directional light projector before gelation occurs.

16. The system of claim 12, wherein the at least one diffuse curing system comprises at least one of a photon source, a LED source, a lamp, or a non-LED source.

17. The system of claim 12, wherein the control subsystem is configured to stop the at least one directional light projector from irradiating the volume of photocurable resin after the pre-gelation duration.
